(19) United States
(12) Patent Application Publication
(10) Pub. No.: US 2006/0010796 A1
(43) Pub. Date: Jan. 19, 2006

(54) Defrosting and heat-insulating device for window

(76) Inventor: Kimio Akutsu, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/180,719

(22) Filed: Jul. 14, 2005

(30) Foreign Application Priority Data
Jul. 15, 2004 (JP) 2004-208036
Dec. 15, 2004 (JP) 2004-362429

(51) Int. Cl. E06B 3/00

(52) U.S. Cl. 52/204.5

(57) ABSTRACT

A defrosting and heat-insulating device for a window includes a mounting plate part 12a defining a first opening 12ah peripherally with four sides of an arbitrary width, assuming a rectangular external shape identical in size with the external shape of a window glass G, and mounted in conjunction with the window glass G on the screen frame F of the glass screen S, a frame part 12c defining a second opening 12ch peripherally with four sides of an arbitrary width, disposed in a state laid peripherally on the mounting plate part 12a on the side thereof opposite the window glass G to protrude outward, and provided with a step 12ca disposed peripherally on the inner peripheral edge defining the second opening 12ch, and a plate body 21 mounted on the step 12ca and adapted to form an air layer a of a prescribed thickness between itself and the window glass G. The device is consequently capable of producing a fully satisfactory defrosting and heat-insulating effect, allowing the mounting work to be simplified and enabling the mounting work to be performed with high workability.

### BACKGROUND OF THE INVENTION

1. Field of the Invention

This invention relates to a defrosting and heat-insulating device for a window which, when fit on the window glass of an existing glass window or fit on the window glass and on a screen frame as well in the case of the window glass pieced in combination with a glass screen, prevents the window glass from frosting and insulates the inside of the window glass from the outside thereof.

2. Description of the Prior Art

The dew is formed when the screen frame and the window glass of an aluminum sash, for example, are cooled by the low outdoor temperature and the temperature on the indoor side surface of the window glass is vastly lowered as compared with the room interior temperature and, as a result, the steam contained in the air on the indoor side is liquefied and caused to adhere in the form of water drops to the window glass. The water drops of the dew formed on the window glass not only defile the cloth of the curtain used inside the room but also degrade the effect of warming the room interior during the winter season and induce a loss of energy. The practice of forming a window glass in a double-wall structure has been known as a means to preclude this adversity.

Since the formation of the window glass of an existing glass window in a double-wall structure incurs a difficult work, a defrosting and heat-insulating device for a window which prevents the window glass fit in a screen frame from frosting and, at the same time, insulates the room interior from the outside by pasting a spacer tape along the outer peripheral part of the window glass and pasting an insulating film on the spacer tape so as to have an air layer interposed between the spacer tape and the window glass has been proposed (refer, for example, to JP-A 2004-76545).

The defrosting and heat-insulating device for a window which forms an air layer between a window glass and an insulating film pasted in advance to the window glass through a spacer tape as described above, however, entails the problem of failing to obtain a fully satisfactory defrosting and insulating effect because it is incapable of giving the air layer a sufficient thickness. Further, since this device requires the work of pasting the spacer tape on the window glass and subsequently pasting the insulating film on the spacer tape to be performed on the spot, it incurs difficulty in accomplishing the fitting work with satisfactory workability.

This invention has been directed toward eliminating the disadvantage mentioned above and has for an object thereof the provision of a defrosting and heat-insulating device for a window which is capable of obtaining a satisfactory defrosting and insulating effect, simplifying the fitting work and enabling the fitting work to be carried out with high workability.

### SUMMARY OF THE INVENTION

The defrosting and heat-insulating device contemplated by this invention comprises a mounting plate part defining a first opening peripherally with four peripheral sides of an arbitrary width, assuming a rectangular external shape identical in size with an external shape of a window glass, and mounted in conjunction with the window glass on a screen frame of a glass screen, a frame part defining a second opening peripherally with four sides of an arbitrary width and disposed in a state laid peripherally the mounting plate part on a side of the mounting plate part opposite the window glass to protrude outward, and a plate body mounted on the frame part so as to block the second opening and forming an air layer of a prescribed thickness between itself and the window glass.

In the defrosting and heat-insulating device for a window, the plate body is mounted on the frame part on a side of the frame part opposite the window glass.

In the defrosting and heat-insulating device for a window, the frame part is provided with a mounting part disposed peripherally around an inner peripheral edge thereof and the plate body is mounted on the mounting plate.

In the defrosting and heat-insulating device for a window, ventilating through holes for enabling the air layer to communicate with an exterior are disposed in an upper part of the frame part forming bilateral sides and in an upper part of the frame part forming a lower side.

In the defrosting and heat-insulating device for a window, the mounting plate part and the frame part are integrally formed.

In the defrosting and heat-insulating device for a window, the peripheral mounting part constitutes a step and the mounting plate part and the frame part are integrally formed.

In the defrosting and heat-insulating device for a window, the mounting plate part and the frame part are each divided into two identical shapes and are integrally formed.

In the defrosting and heat-insulating device for a window, the frame part and the window glass have formed therebetween a gap communicating with the air layer.

In the defrosting and heat-insulating device for a window, the frame part is provided with the mounting plate part through a connecting part disposed peripherally on an inner peripheral edge part of the mounting plate part and raised to a prescribed height.

In the defrosting and heat-insulating device for a window, ventilating through holes for enabling the air layer to communicate with an exterior are disposed on at least either of an upper part of the connecting part forming the bilateral sides and an upper part of the frame part forming the bilateral sides and on at least either of the connecting part forming a lower side and the frame part forming a lower side.

In the defrosting and heat-insulating device for a window, the peripheral mounting part constitutes a step and the mounting plate part and the frame part are divided into two identical shapes and are integrally formed.

According to this invention, an air layer of a prescribed thickness can be formed between a window glass and a plate body attached to a frame part and this air layer is enabled to bring a fully satisfactory defrosting and insulating effect.

Since the external shape of the mounting plate part is equalized in size with the external shape of the window glass, the attachment of the window glass to the screen frame enables the mounting plate part to be mounted on the window glass and on the screen frame as well by the use of a sealing member, such as rubber packing. The mounting work is simple and can be performed with highly satisfactory workability. Further, the defrosting and heat-insulating device can be attached to the glass screen from the beginning or during the course of remodeling.

Once the defrosting and heat-insulating device for a window is mounted on the glass screen, the air layer assumes a closed state. An effort to prevent the air layer from admit moisture during the course of mounting the defrosting and heat-insulating device for a window, therefore, results in enabling the defrosting effect to be maintained even in the district of intense cold.

Since the plate body is mounted on the surface of the frame part on the side of the frame part opposite the window glass, the frame part can be formed in a simplified shape.

Owing to the ventilating through holes which are disposed in the upper part of the frame part forming the bilateral sides and in the frame part forming the lower side, even when the moisture happens to enter the air layer during the mounting of the defrosting and heat-insulating device, the moisture in the air layer is expelled because the air warmed when the interior of the air layer is warmed emanates through the ventilating through holes on the upper side and, at the same time, fresh air enters the air layer through the ventilating through holes on the lower side.

Even when the moisture has already entered the air layer during the mounting of the defrosting and heat-insulating device, therefore, the device is capable of bringing the defrosting and insulating effect.

Since the mounting plate part and the frame part are to be formed integrally, the mounting plate part and the frame part can be manufactured with high efficiency.

Further, since the mounting plate part and the frame part are to be divided into two identical shapes and formed integrally, the mounting plate part and the frame part can be manufactured more efficiently and inexpensively.

Since the gap communicating with the air layer is interposed between the frame part and the window glass, the defrosting effect can be obtained even between the frame part and the window glass.

Then, since the connection of the mounting plate part and the frame part with the connecting part enables the gap communicating with the air layer to be interposed between the frame part and the window glass, the defrosting effect can be obtained even between the frame part and the window glass.

### BRIEF EXPLANATION OF THE DRAWING

FIG. 1 is a partly cutaway and partly omitted front view of the defrosting and heat-insulating device as the first embodiment of this invention.

FIG. 2 is a partly cutaway disassembled perspective view illustrating the configuration of a frame body shown in FIG. 1.

FIG. 3 is a partly magnified cross section taken through the defrosting and heat-insulating device for a window shown in FIG. 1 across line III-III of FIG. 1 depicting the state of the device mounted on the glass screen.

FIG. 4 is a partly cutaway and partly omitted front view of the defrosting and heat-insulating device for a window as the second embodiment of this invention.

FIG. 5 is a partly cutaway disassembled perspective view illustrating the configuration of a frame body shown in FIG. 4.

FIG. 6 is a partly magnified cross section taken through the defrosting and heat-insulating device for a window shown in FIG. 4 across line VI-VI of FIG. 4 depicting the state of the device mounted on the glass screen.

FIG. 7 is a partly cutaway and partly omitted front view of the defrosting and heat-insulating device for a window as the third embodiment of this invention.

FIG. 8 is a partly cutaway disassembled perspective view illustrating the configuration of a frame body shown in FIG. 7.

FIG. 9 is a partly magnified cross section taken through the defrosting and heat-insulating device for a window shown in FIG. 7 across line IX-IX of FIG. 7 depicting the state of the device mounted on a glass screen.

FIG. 10 is a partly cutaway and partly omitted front view of the defrosting and heat-insulating device for a window as the fourth embodiment of this invention.

FIG. 11 is a partly cutaway disassembled perspective view illustrating the configuration of a frame body shown in FIG. 10.

FIG. 12 is a partly magnified cross section taken through the defrosting and heat-insulating device for a window shown in FIG. 10 across line XII-XII of FIG. 10 depicting the state of the device mounted on a glass screen.

FIG. 13 is a partly cutaway part perspective view illustrating the configuration of a frame body to be used in the defrosting and heat-insulating device for a window as the fifth embodiment of this invention.

FIG. 14 is a partly magnified cross section illustrating the state in which the defrosting and heat-insulating device for a window as the fifth embodiment of this invention using the frame body shown in FIG. 13 is mounted on the glass screen.

FIG. 15 is a partly magnified cross section illustrating the state in which the defrosting and heat-insulating device for a window as the sixth embodiment of this invention is mounted on the glass screen.

FIG. 16 is a partly magnified cross section illustrating the state in which the defrosting and heat-insulating device for a window as the seventh embodiment of this invention is lapped on the window glass.

FIG. 17 is a partly magnified cross section illustrating the state in which the defrosting and heat-insulating device for a window as the eighth embodiment of this invention is lapped on the window glass.

FIG. 18 is a partly magnified cross section illustrating the state in which the defrosting and heat-insulating device for a window as the ninth embodiment of this invention is lapped on the window glass.

FIG. 19 is a partly magnified cross section illustrating the state in which the defrosting and heat-insulating device for a window as the tenth embodiment of this invention is lapped on the window glass.

### DESCRIPTION OF THE PREFERRED EMBODIMENT

Now, the embodiments of this invention will be described below with reference to the accompanying drawings.

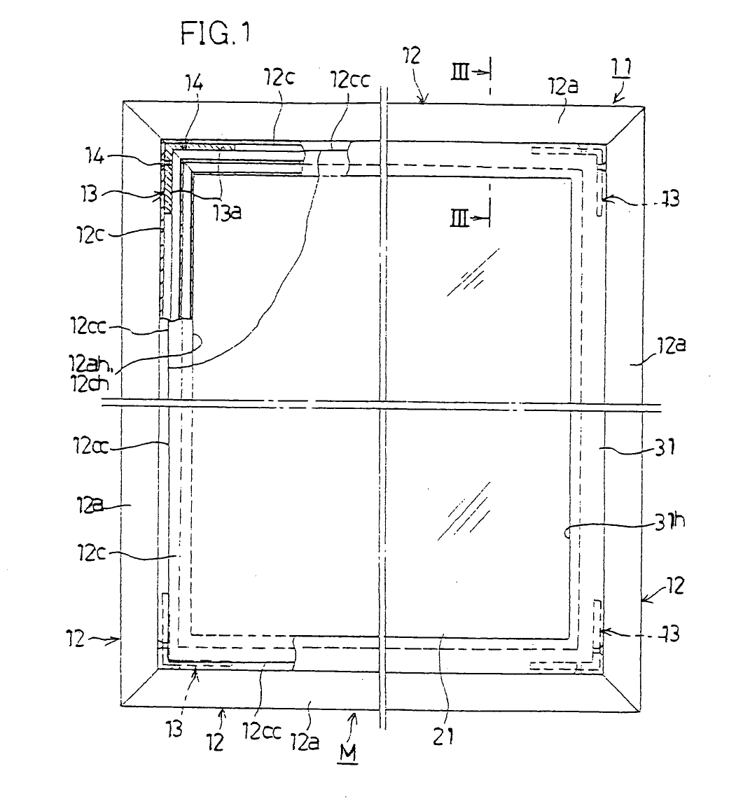

FIGS. 1 to 3 illustrate the defrosting and heat-insulating device for a window as the first embodiment of this invention.

In these diagrams, a defrosting and heat-insulating device M for a window comprises a frame body 11 identical in size with the external shape of a window glass G, a plate body 21 fixed with a double-sided adhesive tape, for example, to the surface of the frame body 11 on the side of the frame body opposite the window glass G, and a facing plate 31 fixed with a double-sided adhesive tape, for example, to the plate body 21.

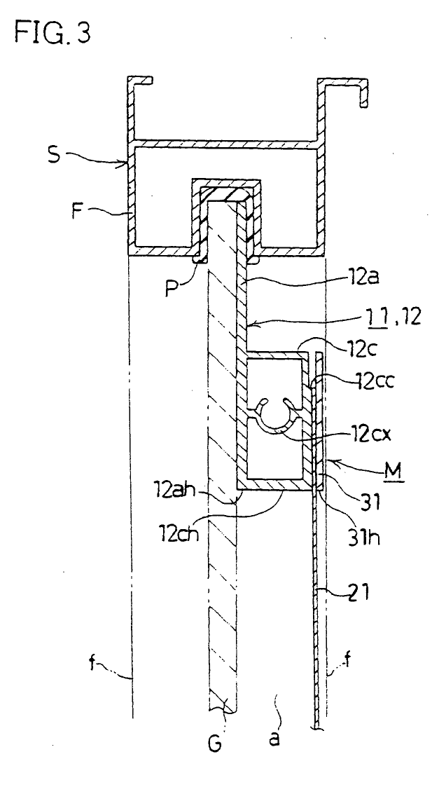

Incidentally, the thickness of the defrosting and heat-insulating device M for a window, namely the thickness resulting from adding the thicknesses of the plate body 21 and the facing plate 31 to the thickness of the frame body 11, is supposed to be such that the frame body 11, when mounted in conjunction with the window glass G on a screen frame F as illustrated in FIG. 3, may not protrude from the surface formed by the screen frame F.

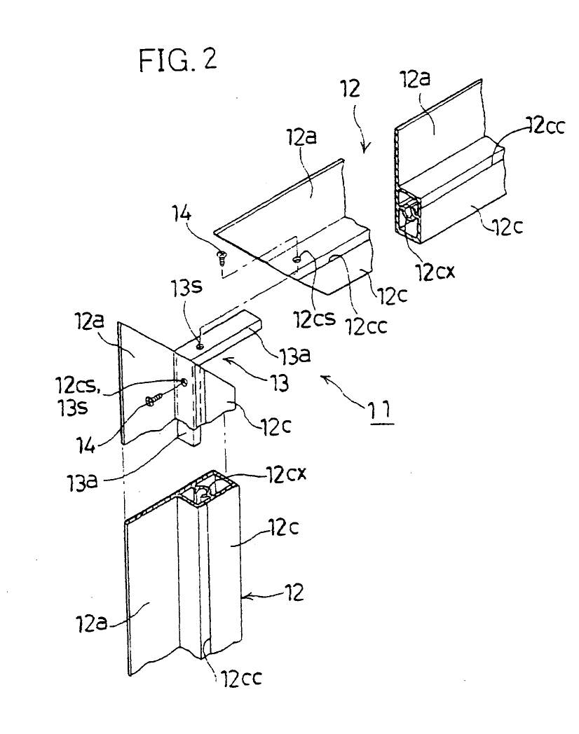

The frame body 11 is produced by extrusion molding aluminum, for example, in a jointly rectangular shape in front view identical in size with the external shape of the window glass G as illustrated in FIGS. 1 to 3 and comprises four frame members 12 each in a trapezoidal shape in front view having an inclined plane forming an angle of inclination of 45 degrees, connecting pieces 13 of aluminum, for example, so adapted that each of the pairs of the connecting pieces 13a joined at an angle of 90 degrees may be inserted into the adjoining frame members 12, with the object of completing the frame member 12 as illustrated in FIGS. 1 and 2, and countersunk screws 14 serving as fixing screws for fixing the connecting parts 13a of the connecting pieces 13 to the frame members 12 as illustrated in FIGS. 1 and 2.

Then, the frame members 12 are each formed of a mounting plate part 12a in a trapezoidal shape in front view defining a first opening 12ah and adapted to be mounted in conjunction with the window glass G to the screen frame F of a glass screen S and a frame part 12c defining a second opening 12ch and disposed in such a state that the mounting plate part 12a may protrude to the outside of the mounting plate part 12a on the side of the mounting plate part opposite the window glass G.

The frame part 12c is provided with a reinforcing part 12cx interconnecting and reinforcing the central parts of the long sides, possessing a C-shaped part allowing a screw to be helically fit at the center, and continuing in the longitudinal direction, provided at each of the outer opposite terminal parts thereof with an insertion hole 12cs in the shape of a truncated cone, for example, and provided on the surface thereof opposite the window glass G with a rectilinearly extended cutting step 12cc having the outside depressed more than the inside toward the window glass G.

Then, the connecting piece 13 is provided on the outside part thereof corresponding to the insertion hole 12cs of the relevant connecting part 13a with a threaded hole 13s adapted to be meshed with the countersunk screw 14 as illustrated in FIG. 2.

When the frame members 12 are connected to each other and the connecting parts are sealed, therefore, the mounting plate parts 12a and the frame parts 12c are caused to continue into a rectangular shape and enabled to define the first opening 12ah and second opening 12ch.

The plate body 21 is what is obtained by fastening a commercially available heat ray cutting film capable of intercepting heat ray, such as infrared ray, for example, to at least one side of a thin plastic film or a thick heat ray cutting film.

The facing plate 31 is formed in the same shape as the peripheral frame part 12c and is provided with an opening 31h identical in shape with the second opening 12ch of the frame part 12c.

The glass screen denoted by S comprises a screen frame F, the window glass G fit in the screen frame F and a rubber packing P as a peripheral sealing material for sealing the gap between the window glass G and the screen frame F.

Now, the assemblage of the defrosting and heat-insulating device for a window as the first embodiment of this invention will be described below.

First, the frame body 11 is assembled by positioning the four frame members 12 with the parts thereof provided with the cutting step 12cc held on the outer side and connecting and fixing them in a joint rectangular shape by the use of the connecting piece 13 and the countersunk screw 14 as illustrated in FIG. 2 and sealing the connecting parts as well.

Then, a double-sided adhesive tape (not shown) is peripherally fastened to the inner side (the part of a larger thickness) of the cutting step 12cc of the frame part 12c as illustrated in FIG. 1 and FIG. 3, and the plate body 21 is fastened to the frame part 12c by utilizing the double-sided adhesive tape so as to block the second opening 12ch.

After the plate body 21 has been fastened to the frame part 12c as described above, the blade of a cutter is applied to the part of the cutting step 12cc from above the plate body 21 and then moved along the cutting step 12cc to cut the plate body 21 in the shape of the cutting step 12cc. The outer part of the plate body 21 separated by the cutting is expelled.

Then, the assemblage of the defrosting and heat-insulating device M for a window is completed by lapping the facing plate 31 to the frame part 12c after the double-sided adhesive tape (not shown) is peripherally fastened to the surface of the facing plate 31 about to be fastened to the plate body 21 in conformity with the inner side of the cutting step 12cc of the frame part 12c or after the double-sided adhesive tape (not shown) is peripherally fastened to the part corresponding to the inner side of the cutting step 12cc to which the facing plate 31 of the plate body 21 is about to be fastened and also fastening the facing plate 31 to the plate body 21 in such a manner as to superpose the two openings 12ch and 31h.

Then, the mounting of the defrosting and heat-insulating device M for a window of the first embodiment on the glass screen S will be described below.

The mounting of the defrosting and heat-insulating device M for a window on the glass screen S is completed by lapping the mounting plate part 12a of the defrosting and heat-insulating device M for a window which has been assembled as described above on the window glass G and assembling the mounting plate part 12a and the window glass G together with the glass screen S. The glass screen S which has been assembled is then mounted in a window frame.

Incidentally, when the defrosting and heat-insulating device M for a window is mounted on the glass screen S, a closed air layer a measuring not less than 2 mm in thickness is formed between the window glass G and the plate body 21.

This air layer a can bring a fully satisfactory defrosting effect and heat-insulating effect when the thickness thereof is not less than 2 mm

According to the first embodiment of this invention, since the air layer a of the prescribed thickness can be formed between the window glass G and the plate body 21 mounted on the surface of the frame part 12c on the side of the frame part opposite the window glass G, the defrosting and heat-insulating device M for a window is enabled to derive a fully satisfactory defrosting effect and heat-insulating effect from this air layer a.

Since the external shape of the mounting plate part 12a is equalized with the external shape of the window glass G, the mounting plate part 12a can be mounted in conjunction with the window glass G on the screen frame F by using a sealing material, such as rubber packing P, during the course of mounting the window glass G on the screen frame F. Thus, the mounting work is simple and can be performed with high workability and, at the same time, the defrosting and heat-insulating device M for a window can be mounted in the glass screen S either from the beginning or during the course of remodeling.

Further, since the air layer a assumes a closed state when the defrosting and heat-insulating device M for a window is mounted on the glass screen S, an effort to keep moisture from entering the air layer a during the course of mounting the defrosting and heat-insulating device M for a window results in enabling this device M to maintain a defrosting effect even in the district of intense cold.

Then, the frame part 12c can be formed in a simple shape because the plate body 21 is mounted on the surface of the frame part 12c on the side of the frame part opposite the window glass G.

Since the heat ray cutting film is used as the plate body 21, the heat ray from the exterior of the room can be intercepted by the plate body 21 and the rise of temperature inside the room can be curbed.

Since the peripheral cutting step 12cc depressed more on the outer side toward the window glass G side than on the inner side is formed on the surface of the frame part 12c on the side of the frame part opposite the window glass G, the plate body 21 can be cut in the shape of the cutting step 12cc by applying the blade of a cutter from above the plate body 21 to the part of the cutting step 12cc and moving the blade of the cutter along the cutting step 12cc without being guided along a ruler.

Further, since the facing plate 31 identical in shape with the plate body 21 is fastened through the platen body 21 to the surface of the frame part 12c on the side of the frame part opposite the window glass G, the plate body 21 is enabled to look to advantage by having the cut edge thereof concealed with the facing plate 31.

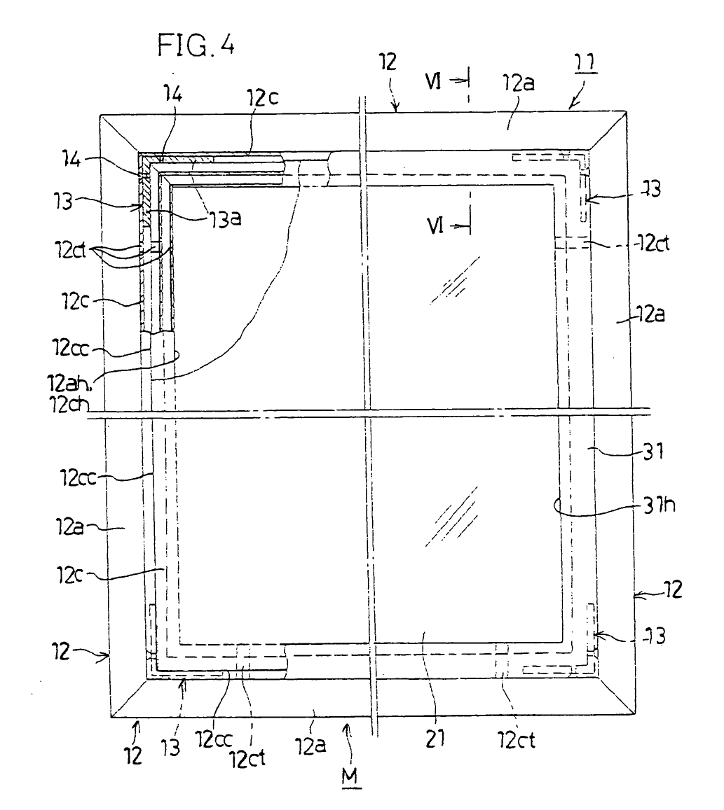

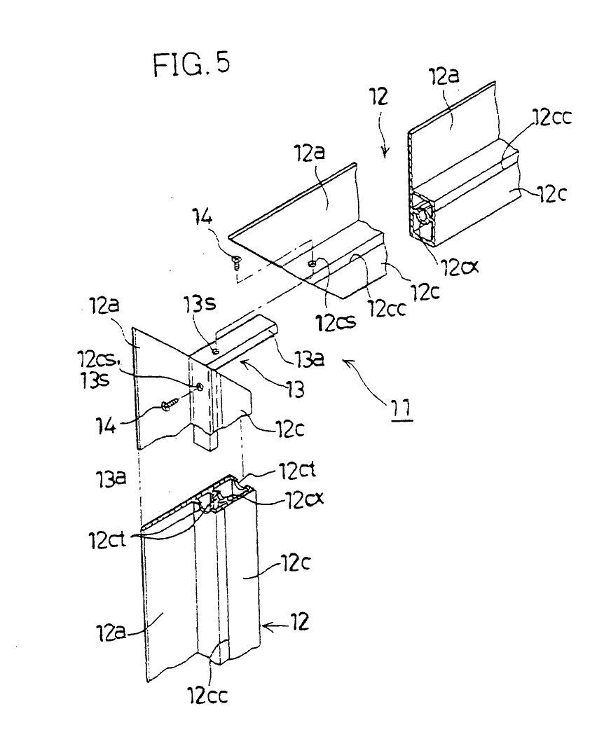

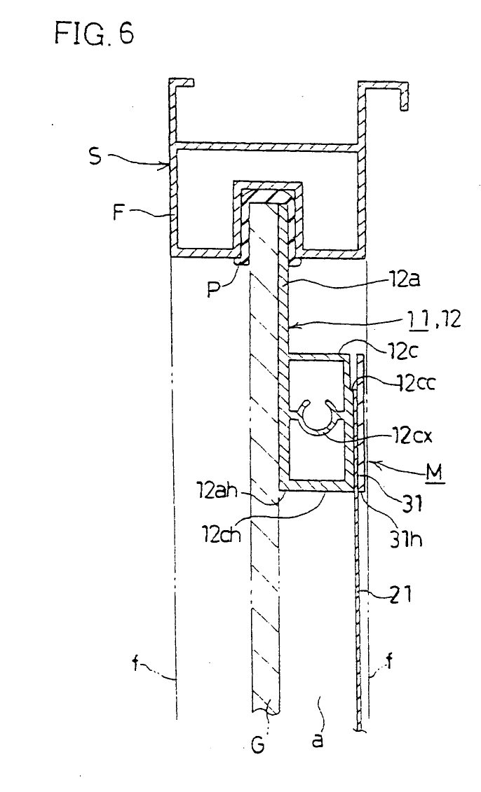

FIG. 4 is a partly cutaway and partly omitted front view of the defrosting and heat-insulating device M for a window as the second embodiment of this invention, FIG. 5 is a partly cutaway disassembled perspective view illustrating the configuration of the frame body 11 shown in FIG. 4, and FIG. 6 is a partly magnified cross section taken through the defrosting and heat-insulating device M for a window shown in FIG. 4 across line VI-VI of FIG. 4 depicting the state of the device mounted on the glass screen S. In these diagrams, the parts identical with or equivalent to the parts shown in FIGS. 1 to 3 are denoted by identical reference numerals and will be omitted from the following description.

The defrosting and heat-insulating device M for a window according to the second embodiment differs from the defrosting and heat-insulating device M for a window according to the first embodiment in having one (or two) ventilating through hole 12ct for enabling the air layer a to communicate with the exterior disposed in the upper part of the frame part 12c forming the bilateral sides and having a plurality, two (or three), for example, of ventilating through holes 21ct disposed as spaced in the frame part 12c forming the lower side.

The assemblage of the defrosting and heat-insulating device M for a window according to the second embodiment and the mounting thereof on the glass screen S are similar to those of the first embodiment and, therefore, will be omitted from the description here.

Incidentally, the thickness of the defrosting and heat-insulating device M for a window ought to be such that when the frame body 11 is fastened to the glass screen S, it may not protrude from the surface f formed by the screen frame F as shown in FIG. 6.

When the defrosting and heat-insulating device M for a window is mounted on the glass screen S, the air layer a having a thickness of not less than 2 mm is formed between the window glass G and the plate body 21.

Also in the second embodiment of this invention, the same effect as in the first embodiment can be obtained. Owing to the provision of ventilating through holes 12ct for the upper part of the frame part 12c forming the bilateral sides and for the frame part 12c forming the lower side, even when moisture happens to enter the air layer a during the course of mounting the defrosting and heat-insulating device M for a window, the air warmed when the interior of the air layer a is warmed emanates from the ventilating through hole 12ct on the upper side and, at the same time, the air enters the air layer a through the ventilating through hole 12ct on the lower side, with the result that the moisture in the air layer a will be discharged.

When the moisture happens to enter the air layer a while the defrosting and heat-insulating device M for a window is being mounted, the device is still capable of bringing a defrosting effect and a heat-insulating effect.

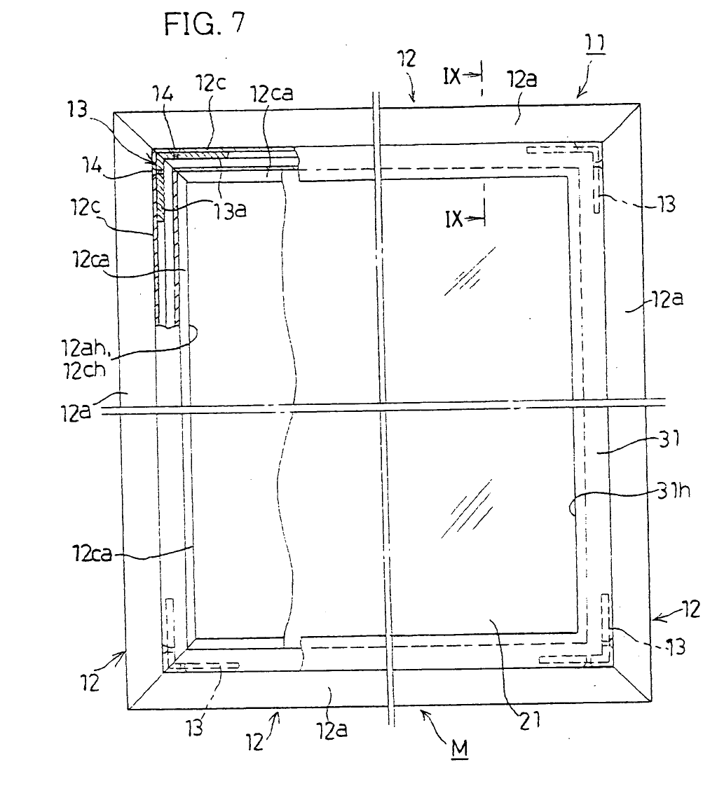

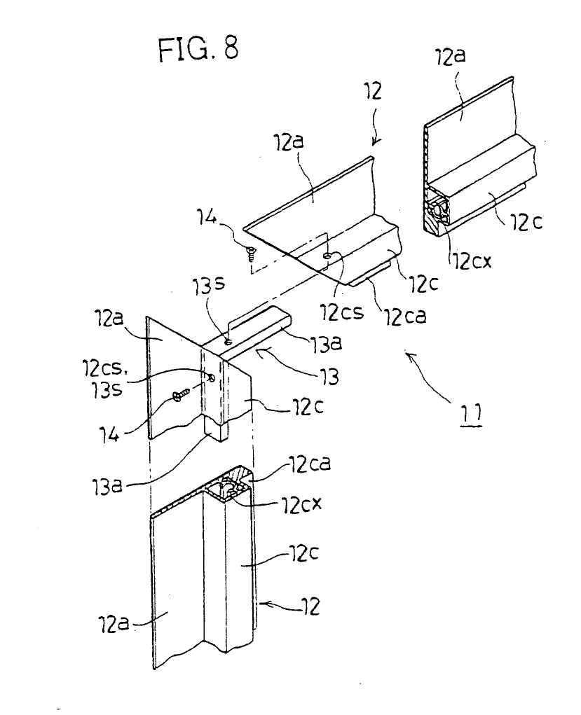

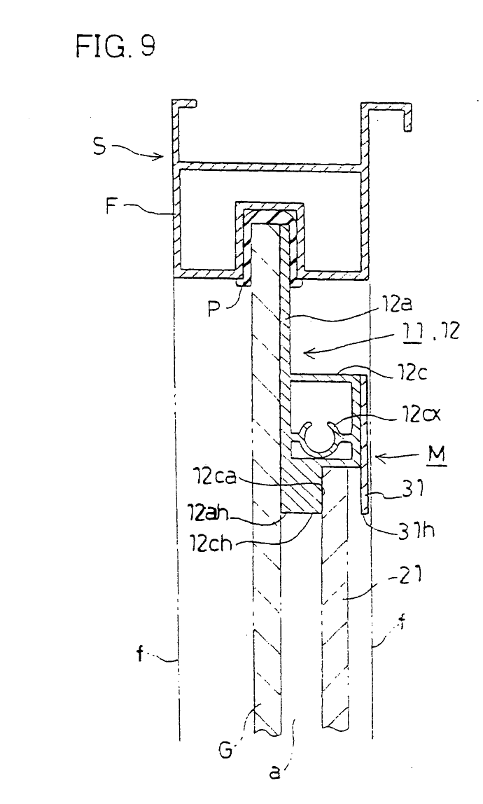

FIG. 7 is a partly cutaway and partly omitted front view of the defrosting and heat-insulating device M for a window as the third embodiment of this invention, FIG. 8 is a partly cutaway disassembled part perspective view illustrating the configuration of a frame body 11 shown in FIG. 7, and FIG. 9 is a partly magnified cross section taken through the defrosting and heat-insulating device M for a window shown in FIG. 7 across line IX-IX of FIG. 7 depicting the state of the device mounted on a glass screen S. In these diagrams, the parts identical with or equivalent to the parts shown in FIGS. 1 to 6 are denoted by identical reference numerals.

The defrosting and heat-insulating device M for a window shown in these diagrams comprises the frame body 11 identical in size with the external shape of the window glass G, the plate body 21 fastened with a double-sided adhesive tape, for example, to the step 12ca provided for the frame body 11 on the side of the frame body opposite the window glass G and having a thickness smaller than the height of the step 12ca, and the facing plate 31 fastened with a double-sided adhesive tape, for example, to the surface of the frame body 11 on the side of the frame body opposite the window glass G.

Incidentally, the thickness of the defrosting and heat-insulating device M for a window, namely the thickness resulting from adding the thickness of the facing plate 31 to the thickness of the frame body 11 ought to be such that when the frame body 11 is mounted in conjunction with the window glass G on the screen frame F as illustrated in FIG. 9, the thickness may not protrude from the surface f which is formed by the screen frame F.

The frame body 11 is produced by extrusion-molding aluminum, for example, in a jointly rectangular shape in front view identical in size with the external shape of the window glass G as illustrated in FIGS. 7 to 9 and comprises four frame members 12 each in a trapezoidal shape in front view having an inclined plane forming an angle of inclination of 45 degrees, connecting pieces 13 of aluminum, for example, so adapted that each of the pairs of the connecting pieces 13a joined at an angle of 90 degrees may be inserted into the adjoining frame members 12 with the object of completing the frame member 12 as illustrated in FIGS. 7 and 8, and countersunk screws 14 serving as fixing screws for fixing the connecting parts 13a of the connecting pieces 13 to the frame members 12 as illustrated in FIGS. 7 and 8.

The frame members 12 each comprise the mounting plate part 12a of a trapezoidal shape in front view forming the first opening 12ah and mounted in conjunction with the window glass G on the screen frame F of the glass screen S and the frame part 12c forming the second opening 12ch, disposed on the side of the mounting plate part 12a opposite the window glass G in such a state allowing the mounting plate part 12a to thrust outward, and provided on the inner peripheral edge forming the second opening 12ch with the step 12ca as a mounting part.

This frame part 12c is provided with the reinforcing part 12cx interconnecting and reinforcing the central parts of the long sides, possessing a C-shaped part allowing a screw to be helically fit at the center, and continuing in the longitudinal direction and provided at each of the outer opposite terminal parts thereof with the insertion hole 12cs in the shape of a truncated cone, for example.

Then, the connecting piece 13 is provided on the outside part thereof corresponding to the insertion hole 12cs of the relevant connecting part 13a with a threaded hole 13s adapted to be meshed with the countersunk screw 14 as illustrated in FIG. 8.

When the frame members 12 are connected to each other and the connecting parts are sealed, therefore, the mounting plate parts 12a and the frame parts 12c are caused to continue into a rectangular shape and enabled to define the first opening 12ah and second opening 12ch.

The plate body 21 is what is obtained by fastening a commercially available heat ray cutting film capable of intercepting heat ray, such as infrared ray, for example, to at least one side of a thin plastic film or a thick heat ray cutting film.

The facing plate 31 is formed in the same shape as the peripheral frame part 12c and is provided with an opening 31h identical in shape with the second opening 12ch of the frame part 12c.

The glass screen denoted by S comprises the screen frame F, the window glass G fit in the screen frame F and the rubber packing P as a peripheral sealing material for sealing the gap between the window glass G and the screen frame F.

Now, the assemblage of the defrosting and heat-insulating device M for a window as the third embodiment of this invention will be described below.

First, the frame body 11 is assembled by placing the four frame members 12 with the surfaces thereof containing the step 12ca held on the inside as illustrated in FIG. 8, connecting and fixing them in a joint rectangular shape by the use of the connecting piece 13 and the countersunk screw 14, and sealing the connecting parts as well.

Then, a double-sided adhesive tape (omitted from illustration) is attached peripherally to the step 12ca (the part destined to be parallel to the mounting plate part 12a) of the frame body 11 as illustrated in FIG. 7 and FIG. 9. The plate body 21 is fastened to the step 12ca by utilizing the double-sided adhesive tape so as to block the second opening 12ch of the frame part 12c.

The assemblage of the defrosting and heat-insulating device M for a window is then completed by fastening the double-sided adhesive tape (omitted from illustration) peripherally to the surface of the frame part 12c on the side of the frame part opposite the mounting plate part 12a, lapping the facing plate 31 on the frame part 12c, and fastening the facing plate 31 to the frame part 12c so as to induce superposition of the two openings 12ch and 31h.

The mounting of the defrosting and heat-insulating device M for a window according to the third embodiment is the same as in the first embodiment and will be omitted from description here.

Incidentally, when the defrosting and heat-insulating device M for a window is mounted on the glass screen S, the closed air layer a having a thickness of not less than 2 mm is formed between the window glass G and the plate body 21 as illustrated in FIG. 9.

Also in this third embodiment, the same effect as in the first embodiment can be obtained. The plate body 21 can be mounted in a hardly unlockable state because this mounting is made inside the step 12ca which is disposed peripherally around the inner peripheral edge of the frame part 12c.

Further, since the facing plate 31 identical in shape with the frame part 12c is fastened to the surface of the frame part 12c on the side of the frame part opposite the window glass G, the frame part 12c is enabled to look to advantage by having the edge thereof concealed with the facing plate 31.

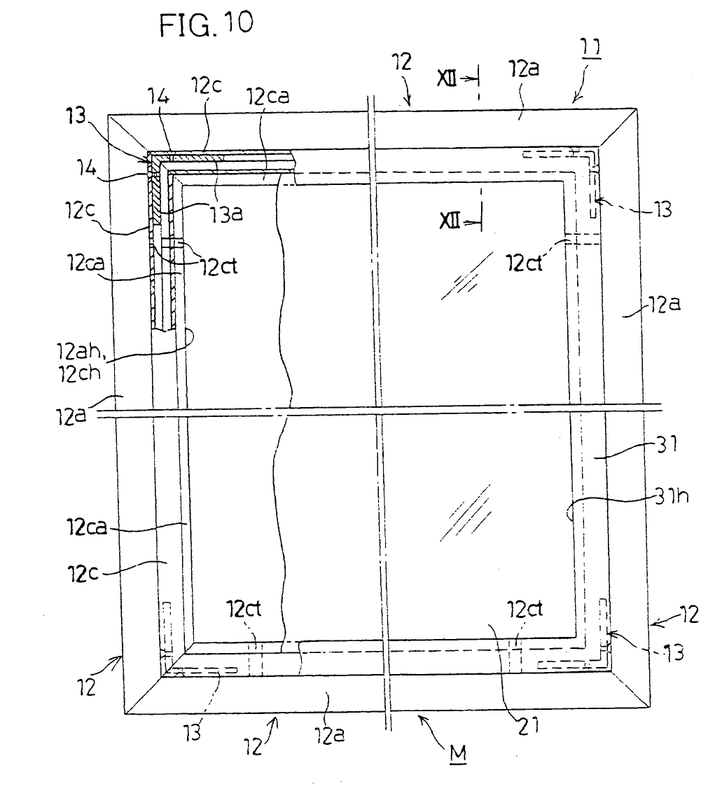

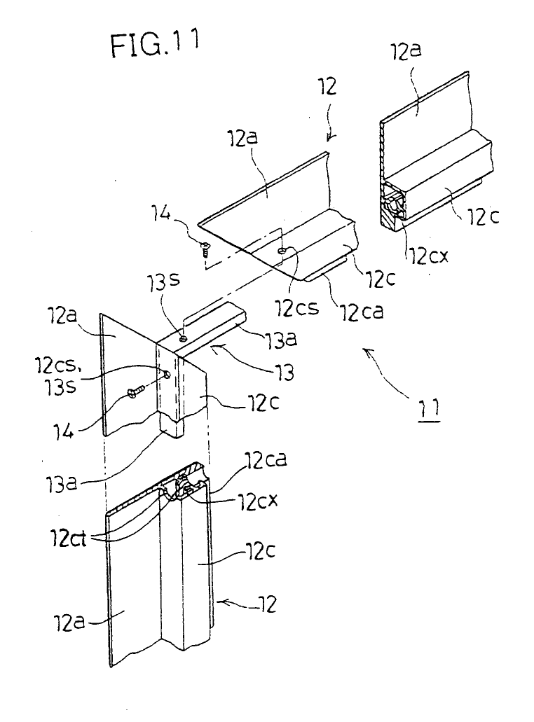

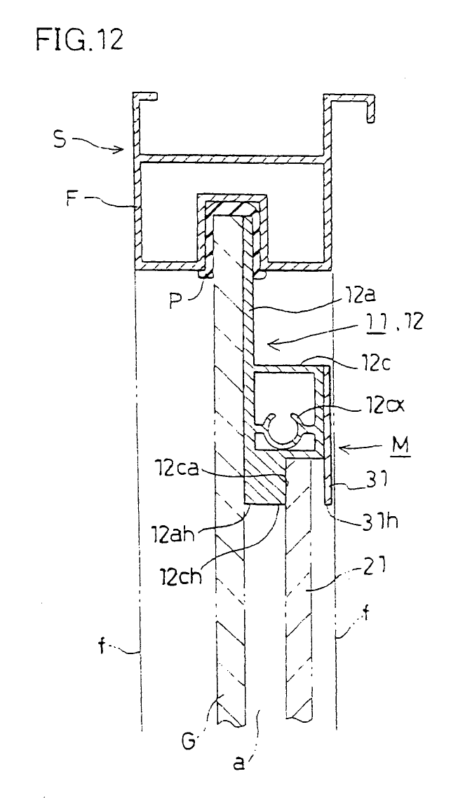

FIG. 10 is a partly cutaway and partly omitted front view of the defrosting and heat-insulating device M for a window as the fourth embodiment of this invention, FIG. 11 is a partly cutaway disassembled perspective view illustrating the configuration of the frame body 11 shown in FIG. 10, and FIG. 12 is a partly magnified cross section taken through the defrosting and heat-insulating device M for a window shown in FIG. 10 across line XII-XII of FIG. 10 depicting the state of the device mounted on the glass screen. In these diagrams, the parts identical with or equivalent to the parts shown in FIG. 1 to 9 are denoted by the identical reference numerals and will be omitted from description here.

The defrosting and heat-insulating device M for a window according to the fourth embodiment differs from the defrosting and heat-insulating device M for a window according to the third embodiment in having one (or two) ventilating through hole 12ct for enabling the air layer a to communicate with the exterior disposed in the upper part of the frame part 12c forming the bilateral sides and having a plurality, two (or three), for example, of ventilating through holes 21ct disposed as spaced in the frame part 12c forming the lower side.

The assemblage of the defrosting and heat-insulating device M for a window according to the fourth embodiment and the mounting thereof on the glass screen S are similar to those of the first embodiment and, therefore, will be omitted from the description here.

Incidentally, the thickness of the defrosting and heat-insulating device M for a window ought to be such that when the frame body 11 is fastened to the glass screen S as illustrated in FIG. 12, the thickness may not protrude from the surface f formed by the screen frame F.

When the defrosting and heat-insulating device M for a window is mounted on the glass screen S, the air layer a having a thickness of not less than 2 mm is formed between the window glass G and the plate body 21.

Also in the fourth embodiment of this invention, the same effect as in the first embodiment can be obtained.

Owing to the provision of ventilating through holes 12ct for the upper part of the frame part 12c forming the bilateral sides and for the frame part 12c forming the lower side, even when moisture happens to enter the air layer a during the course of mounting the defrosting and heat-insulating device M for a window, the air warmed when the interior of the air layer a is warmed emanates from the ventilating through hole 12ct on the upper side and, at the same time, the air enters the air layer a through the ventilating through hole 12ct on the lower side, with the result that the moisture in the air layer a will be discharged.

When the moisture happens to enter the air layer a while the defrosting and heat-insulating device M for a window is being mounted, the device is still capable of bringing a defrosting effect and a heat-insulating effect.

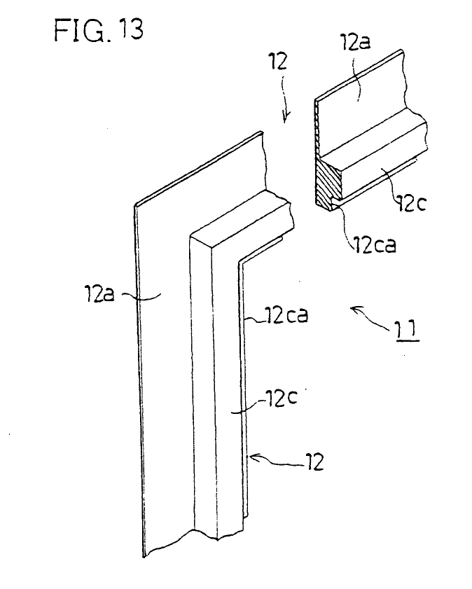

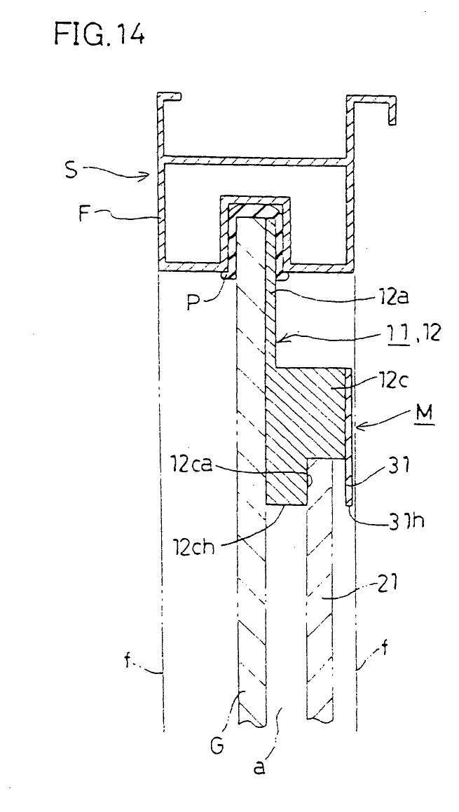

FIG. 13 is a partly cutaway perspective view illustrating the configuration of the frame body 11 to be used in the defrosting and heat-insulating device M for a window as the fifth embodiment of this invention and FIG. 14 is a partly magnified cross section illustrating the state in which the defrosting and heat-insulating device M for a window as the fifth embodiment of this invention using the frame body 11 shown in FIG. 13 is mounted on the glass screen S. In these diagrams, the parts identical with or equivalent to the parts shown in FIG. 1 to 12 are denoted by the same reference numerals and will be omitted from the description here.

The defrosting and heat-insulating device M for a window according to the fifth embodiment differs from the defrosting and heat-insulating device M for a window according to the third embodiment in the fact that the frame body 11 is integrally formed in the state having the four frame members assembled as jointly connected. As a result, the frame part 12c is formed as a solid article.

The assemblage of the defrosting and heat-insulating device M for a window according to the fifth embodiment and the mounting thereof on the glass screen S are similar to those of the first embodiment and, therefore, will be omitted from the description here.

Incidentally, the thickness of the defrosting and heat-insulating device M for a window ought to be such that when the frame body 11 is fastened to the glass screen S as illustrated in FIG. 14, the thickness may not protrude from the surface f formed by the screen frame F.

When the defrosting and heat-insulating device M for a window is mounted on the glass screen S, the air layer a having a thickness of not less than 2 mm is formed between the window glass G and the plate body 21.

Also in this fifth embodiment of this invention, the same effect as in the third embodiment can be obtained. Since the peripheral mounting plate part 12a and the peripheral frame part 12c are integrally formed, the mounting plate part 12a and the frame part 12c can be manufactured efficiently.

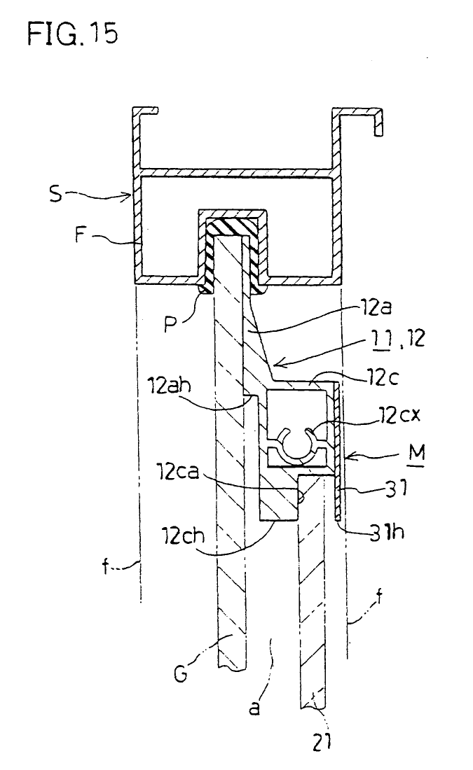

FIG. 15 is a partly magnified cross section illustrating the state in which the defrosting and heat-insulating device M for a window as the sixth embodiment of this invention is mounted on the glass screen. In this diagram, the parts identical with or equivalent to the parts shown in FIG. 1 to 14 are denoted by the same reference numerals and will be omitted from the description here. Incidentally, FIG. 15 is a partly magnified cross section corresponding to FIG. 9.

The defrosting and heat-insulating device M for a window according to the fifth embodiment differs from the defrosting and heat-insulating device M for a window according to the third embodiment in the fact that the inner side (inner periphery) of the mounting plate part 12a is so formed as to gain gradually in wall thickness and a gap communicating with the air layer a is formed between the frame part 12c and the window glass G.

The assemblage of the defrosting and heat-insulating device M for a window according to the sixth embodiment and the mounting thereof on the glass screen S are similar to those of the first embodiment and, therefore, will be omitted from the description here. Incidentally, the thickness of the defrosting and heat-insulating device M for a window ought to be such that when the frame body 11 is fastened to the glass screen S as illustrated in FIG. 14, the thickness may not protrude from the surface f formed by the screen frame F. When the defrosting and heat-insulating device M for a window is mounted on the glass screen S, the air layer a having a thickness of not less than 2 mm is formed between the window glass G and the plate body 21.

Also in this sixth embodiment of this invention, the same effect as in the third embodiment can be obtained. Since the gap communicating with the air layer a is interposed between the frame part 12c and the window glass G, the device of this invention is capable of obtaining the defrosting effect between the frame part 12c and the window glass G.

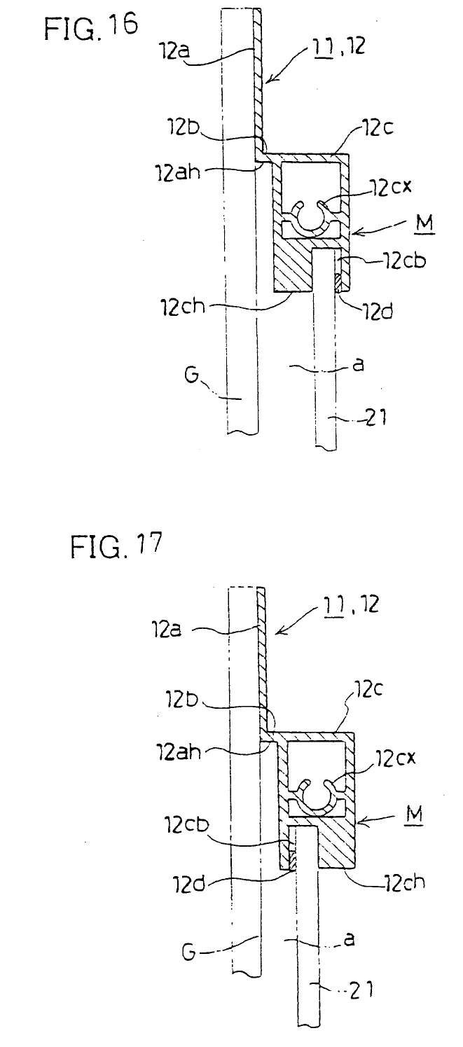

FIG. 16 is a partly magnified cross section illustrating the state in which the defrosting and heat-insulating device M for a window as the seventh embodiment of this invention is lapped on the window glass. In this diagram, the parts identical with or equivalent to the parts shown in FIGS. 1 to 15 are denoted by the same reference numerals and will be omitted from the description here. Incidentally, FIG. 16 is a partly magnified cross section corresponding to FIG. 9.

The defrosting and heat-insulating device M for a window according to the seventh embodiment differs from the defrosting and heat-insulating device M for a window according to the third embodiment in the fact that the frame material 12 is composed of the mounting plate part 12a, a connecting part 12b raised from the inner peripheral edge part of the mounting plate part 12a on the side of the mounting plate part opposite the window glass G to a prescribed height, and the frame part 12c so disposed as to allow the mounting plate part 12a to protrude to the outside of the connecting part 12b on the side of the connecting part opposite the mounting plate part 12a. In the defrosting and heat-insulating device M for a window according to the seventh embodiment, therefore, the mounting plate part 12a defining the first opening 12ah peripherally with the four sides of an arbitrary width, assuming a rectangular external shape identical in size with the external shape of the window glass G, and mounted in conjunction with the window glass G on the screen frame F of the glass screen S and the frame part 12c defining the second opening 12ch with the four sides of an arbitrary width and provided with the step 12ca disposed peripherally on the inner peripheral edge defining the second opening 12ch are connected with the connecting part 12b peripherally raised to a prescribed height to the inner peripheral edge part of the mounting plate part 12sa on the side of the mounting plate part opposite the window glass G in such a manner that the mounting plate part 12a may protrude to the peripheral outer side.

The assemblage of the defrosting and heat-insulating device M for a window according to the seventh embodiment and the mounting thereof on the glass screen S are similar to those of the first embodiment and, therefore, will be omitted from the description here. Incidentally, the thickness of the defrosting and heat-insulating device M for a window ought to be such that when the frame body 11 is fastened to the glass screen S, the thickness may not protrude from the surface f formed by the screen frame F. When the defrosting and heat-insulating device M for a window is mounted on the glass screen S, the air layer a having a thickness of not less than 2 mm is formed between the window glass G and the plate body 21

Also in this seventh embodiment of this invention, the same effect as in the third embodiment can be obtained. When the mounting plate part 12a and the frame part 12c are connected with the connecting part 12b, the connecting art 12b is enabled to provide the gap communicating with the air layer a between the frame part 12c and the window glass G. Thus, the device is capable of bringing the defrosting effect as well between the frame part 12c and the window glass G.

FIG. 17 is a partly magnified cross section illustrating the state in which the defrosting and heat-insulating device M for a window as the eighth embodiment of this invention is lapped on the window glass G. Incidentally, FIG. 17 is a partly magnified cross section corresponding to FIG. 9.

The defrosting and heat-insulating device M for a window according to the eighth embodiment differs from the defrosting and heat-insulating device M for a window according to the seventh embodiment in the fact that the open side of the step 12ca falls on the window glass G side and the facing plate 31 is disposed on the window glass G side of the frame part 12c.

The assemblage of the defrosting and heat-insulating device M for a window according to the eighth embodiment and the mounting thereof on the glass screen S are similar to those of the third embodiment and, therefore, will be omitted from the description here. Incidentally, the thickness of the defrosting and heat-insulating device M for a window ought to be such that when the frame body 11 is fastened to the glass screen S, the thickness may not protrude from the surface f formed by the screen frame F. When the defrosting and heat-insulating device M for a window is mounted on the glass screen S, the air layer a having a thickness of not less than 2 mm is formed between the window glass G and the plate body 21

Also in this eighth embodiment of this invention, the same effect as in the seventh embodiment can be obtained.

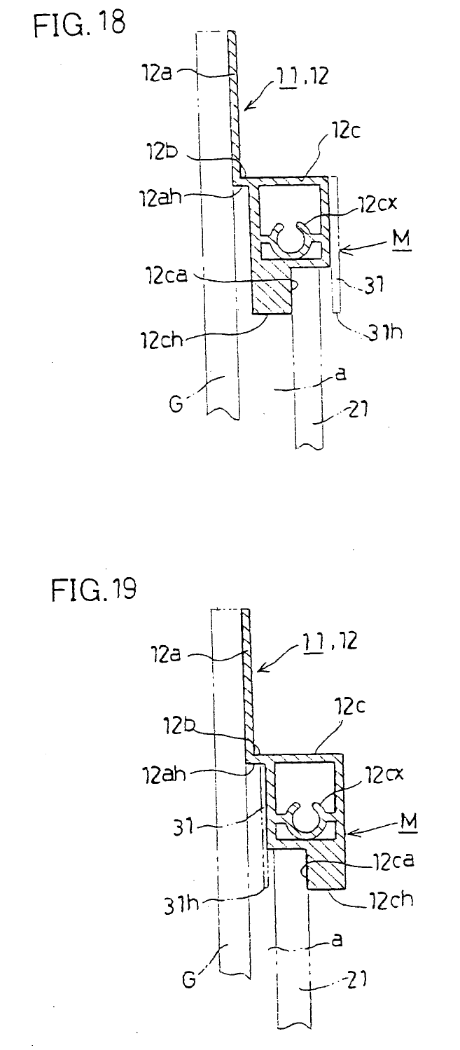

FIG. 18 is a partly magnified cross section illustrating the state in which the defrosting and heat-insulating device M for a window as the ninth embodiment of this invention is lapped on the window glass G. In this diagram, the parts identical with or equivalent to the parts shown in FIGS. 1 to 17 are denoted by the same reference numerals and will be omitted from the description here. Incidentally, FIG. 18 is a partly magnified cross section corresponding to FIG. 9.

The defrosting and heat-insulating device M for a window according to the ninth embodiment differs from the defrosting and heat-insulating device M for a window according to the seventh embodiment in the fact that a depressed part 12cb is peripherally formed around the mounting part. By 12d is denoted a sealing material, such as an adhesive agent. This sealing material serves the purpose of fixing the plate body 21 inside the depressed part 12cb and, at the same time, sealing the gap between the frame part 12c and the plate body 21.

Now, the assemblage of the defrosting and heat-insulating device M for a window according to the ninth embodiment will be described below. First, the plate body 21 is positioned inside the depressed part 12cb while the four frame members 12 are connected and fixed in a rectangular shape by using the connecting pieces 13 and the countersunk screws 14 so as to attain communication peripherally around the depressed part 12cb. Then, the connecting parts of the frame members 12 are sealed and, at the same time, the gap between the frame part 12c and the plate body 21 is sealed by filling the interior of the depressed part 12cb with the sealing member 12d, with the result that the assemblage of the defrosting and heat-insulating device M for a window will be completed.

The defrosting and heat-insulating device M for a window according to the ninth embodiment and the mounting thereof on the glass screen S are similar to those of the first embodiment and, therefore, will be omitted from the description here. Incidentally, the thickness of the defrosting and heat-insulating device M for a window ought to be such that when the frame body 11 is fastened to the glass screen S, the thickness may not protrude from the surface f formed by the screen frame F. When the defrosting and heat-insulating device M for a window is mounted on the glass screen S, the air layer a having a thickness of not less than 2 mm is formed between the window glass G and the plate body 21

Also in the ninth embodiment of this invention, the same effect as in the seventh embodiment can be obtained.

FIG. 19 is a partly magnified cross section illustrating the state in which the defrosting and heat-insulating device M for a window as the tenth embodiment of this invention is lapped on the window glass G. In this diagram, the parts identical with or equivalent to the parts shown in FIGS. 1 to 18 are denoted by the same reference numerals and will be omitted from the description here. Incidentally, FIG. 19 is a partly magnified cross section corresponding to FIG. 9.

The defrosting and heat-insulating device M for a window according to this tenth embodiment differs from the defrosting and heat-insulating device M for a window according to the ninth embodiment in the fact that the depressed part 12cb is disposed on the window glass G side.

The defrosting and heat-insulating device M for a window according to the tenth embodiment and the mounting thereof on the glass screen S are similar to those of the ninth embodiment and, therefore, will be omitted from the description here. Incidentally, the thickness of the defrosting and heat-insulating device M for a window ought to be such that when the frame body 11 is fastened to the glass screen S, the thicknes may not protrude from the surface f formed by the screen frame F. When the defrosting and heat-insulating device M for a window is mounted on the glass screen S, the air layer a having a thickness of not less than 2 mm is formed between the window glass G and the plate body 21.

Also in the tenth embodiment of this invention, the same effect as in the ninth embodiment can be obtained.

Though the preceding fifth embodiment to tenth embodiment have depicted the cases of avoiding provision of a ventilating through hole for enabling the air layer to communicate with the exterior, they may be provided with a ventilating through hole. When the provision of the ventilating through hole is contemplated where the device is provided with a connecting part for connecting the mounting plate part and the frame part, the ventilating through hole may be disposed in at least either of the upper part of the connecting part forming the bilateral sides and the upper part of the frame body forming the bilateral sides or at least either of the connecting part forming the lower side and the frame part forming the lower side. While the first embodiment, the second embodiment and the sixth embodiment to eighth embodiment have depicted the cases of forming the frame body with four frame members, the frame body may be integrally formed as in the fifth embodiment. Further, while the first embodiment to tenth embodiment have depicted the cases of forming the frame body with four frame members or forming the frame body integrally, it is permissible to divide the peripheral mounting plate part and the peripheral frame part each into two identical shapes and forming the divided mounting plate parts and frame parts integrally. When the frame body is divided into two identical shapes as described above, the frame body (the mounting plate part and the frame part) can be manufactured more efficiently and inexpensively. While the first embodiment to fifth embodiment have depicted the cases of avoiding provision of a gap communicating with the air layer between the frame members and the window glass, it is permissible to provide the gap as in the fifth embodiment. When the provision of the gap communicating with the air layer is contemplated, though the gap is preferably laid peripherally, it does not need to be laid peripherally. Though the plate body has been described by citing the case of producing it by pasting a commercially available heat ray cutting film capable of intercepting the heat ray, such as the infrared ray, to at least one side of a thin plate of glass or plastic or using a thick heat ray cutting film, it may be a plate of glass or plastic.

What is claimed is:

1. A defrosting and heat-insulating device for a window, comprising:
a mounting plate part defining a first opening peripherally with four sides of an arbitrary width, assuming a rectangular external shape identical in size with an external shape of a window glass, and mounted in conjunction with the window glass on a screen frame of a glass screen,
a frame part defining a second opening peripherally with four sides of an arbitrary width and disposed in a state laid peripherally on the mounting plate part on a side of the mounting plate part opposite the window glass to protrude outward, and
a plate body mounted on the frame part so as to block the second opening and forming an air layer of a prescribed thickness between itself and the window glass.

2. A defrosting and heat-insulating device for a window according to claim 1, wherein the plate body is mounted on the frame part on a side thereof opposite the window glass.

3. A defrosting and heat-insulating device for a window according to claim 1, wherein the frame part is provided with a mounting part disposed peripherally around an inner peripheral edge thereof and the plate body is mounted on the mounting part.

4. A defrosting and heat-insulating device for a window according to claim 1, wherein ventilating through holes for enabling the air layer to communicate with an exterior are disposed in an upper part of the frame part forming bilateral sides and in the frame part forming a lower side.

5. A defrosting and heat-insulating device for a window according to claim 2, wherein ventilating through holes for enabling the air layer to communicate with an exterior are disposed in an upper part of the frame part forming bilateral sides and in the frame part forming a lower side.

6. A defrosting and heat-insulating device for a window according to claim 3, wherein ventilating through holes for enabling the air layer to communicate with an exterior are disposed in an upper part of the frame part forming bilateral sides and in the frame part forming a lower side.

7. A defrosting and heat-insulating device for a window according to claim 2, wherein the mounting plate part and the frame part are integrally formed.

8. A defrosting and heat-insulating device for a window according to claim 3, wherein the mounting part constitutes a step and the mounting plate part and the frame part are integrally formed.

9. A defrosting and heat-insulating device for a window according to claim 5, wherein the mounting plate part and the frame part are integrally formed.

10. A defrosting and heat-insulating device for a window according to claim 6, wherein the mounting part constitutes a step and the mounting plate part and the frame part are integrally formed.

11. A defrosting and heat-insulating device for a window according to claim 1, wherein the mounting plate part and the frame part are each divided into two identical shapes and are integrally formed.

12. A defrosting and heat-insulating device for a window according to claim 2, wherein the mounting plate part and the frame part are each divided into two identical shapes and are integrally formed.

13. A defrosting and heat-insulating device for a window according to claim 3, wherein the mounting plate part and the frame part are each divided into two identical shapes and are integrally formed.

14. A defrosting and heat-insulating device for a window according to claim 4, wherein the mounting plate part and the frame part are each divided into two identical shapes and are integrally formed.

15. A defrosting and heat-insulating device for a window according to claim 5, wherein the mounting plate part and the frame part are each divided into two identical shapes and are integrally formed.

16. A defrosting and heat-insulating device for a window according to claim 6, wherein the mounting plate part and the frame part are each divided into two identical shapes and are integrally formed.

17. A defrosting and heat-insulating device for a window according to any one of claims 1 to 16, wherein a gap communicating with the air layer is provided between the frame part and the window glass.

18. A defrosting and heat-insulating device for a window according to claim 1, wherein the frame part is provided with the mounting plate part through a connecting part disposed peripherally on an inner peripheral edge part of the mounting plate part as raised to a prescribed height.

19. A defrosting and heat-insulating device for a window according to claim 2, wherein the frame part is provided with the mounting plate part through a connecting part disposed peripherally on an inner peripheral edge part of the mounting plate part as raised to a prescribed height.

20. A defrosting and heat-insulating device for a window according to claim 3, wherein the frame part is provided with the mounting plate part through a connecting part disposed peripherally on an inner peripheral edge part of the mounting plate part as raised to a prescribed height.

21. A defrosting and heat-insulating device for a window according to claim 18, wherein ventilating through holes for enabling the air layer to communicate with an exterior are disposed on at least either of an upper part of the connecting part forming bilateral sides and an upper part of the frame part forming bilateral sides and on at least either of the connecting part forming a lower side and the frame part forming a lower side.

22. A defrosting and heat-insulating device for a window according to claim 19, wherein ventilating through holes for enabling the air layer to communicate with an exterior are disposed on at least either of an upper part of the connecting part forming bilateral sides and an upper part of the frame part forming bilateral sides and on at least either of the connecting part forming a lower side and the frame part forming a lower side.

23. A defrosting and heat-insulating device for a window according to claim 20, wherein ventilating through holes for enabling the air layer to communicate with an exterior are disposed on at least either of an upper part of the connecting part forming bilateral sides and an upper part of the frame part forming bilateral sides and on at least either of the connecting part forming a lower side and the frame part forming a lower side.

24. A defrosting and heat-insulating device for a window according to claim 19 or claim 22, wherein the mounting plate part and the frame part are integrally formed.

25. A defrosting and heat-insulating device for a window according to claim 20 or claim 23, wherein the mounting part constitutes a step and the mounting plate part and the frame part are each divided into two identical shapes and are integrally formed.
